(19) United States
(12) Patent Application Publication
(10) Pub. No.: US 2011/0234035 A1
(43) Pub. Date: Sep. 29, 2011

(54) MAGNETIC COUPLING AND SPLIT CASE FOR A MAGNETIC COUPLING

(76) Inventor: Heinrich Wittschier, Neuenrade (DE)

(21) Appl. No.: 12/998,823

(22) PCT Filed: May 25, 2010
(86) PCT No.: PCT/DE2010/000572

§ 371 Date: Jun. 7, 2011

(30) Foreign Application Priority Data
May 27, 2009 (DE) 10 2009 022 916.7

(51) Int. Cl. H02K 49/10

(52) U.S. Cl. 310/104

(57) ABSTRACT

Magnetic coupling, at least comprising an inner rotor, an outer rotor, and a split case, which is disposed between the inner and outer rotors and is made of an electrically non-conductive material, characterized in that the split case consists exclusively of glass.

The invention relates to a magnetic coupling according to the type-defining part of the first claim.

Split cases, which are usually used in the case of magnetic couplings, consist of metals having the most varied alloy compositions, plastic, ceramic material, glass fiber, or carbon fiber.

Metallic split cases are subject to the problem that high eddy current losses with accompanying high temperatures can lead to significant power losses in the region of the magnetic coupling. This requires electric motors having relatively high power.

Plastic split cases demonstrate the disadvantage that they have only a low temperature and pressure resistance.

Split cases composed of ceramic material have the advantage that no eddy current losses exist and thus also no high temperatures can occur. However, they have the great disadvantage that they are disproportionately expensive in production. Accordingly, economic efficiency, particularly in the sector of magnetic couplings, for example for standard-production pumps, does not exist; instead, such ceramic split cases are usually only used for special productions, in order to justify the high price of such split cases.

DE 20 2004 013 080 U1 relates to a magnetic coupling pump for conveying fluids, having a pump housing that can be mounted onto a motor, having a rotating drive part provided with external magnets, which part can be driven by power from the motor, having a rotating rotor that has a pump shaft, at least one impeller wheel disposed on the pump shaft so as to rotate with it, and internal magnets mounted on the pump shaft so as to rotate with it, whereby a split case is disposed between the external magnets and internal magnets that stand in a magnetic active connection with one another. The split case can consist of a non-conductive ceramic material, so that practically no eddy current losses occur and the fluid, which serves as a lubricant and coolant, is not excessively heated. According to another variant, the split case can consist of metal.

It is the goal of the object of the invention to further develop a magnetic coupling of the stated type to the effect that on the one hand, the advantages of the split cases that consist of ceramic material are maintained, but on the other hand, improved economic efficiency as compared with ceramic material exists.

Furthermore, a split case for a magnetic coupling, consisting of an electrically non-conductive material, is supposed to be made available, which case is simple in structure and can be produced significantly more inexpensively as compared with split cases made of ceramic material.

This goal is achieved, in the case of a magnetic coupling of the stated type, in that the split case consists exclusively of glass.

Advantageous further developments of the magnetic coupling can be derived from the related dependent claims.

This goal is also accomplished by means of a split case that consists exclusively of glass.

Advantageous further developments of the split case according to the invention can be derived from the related dependent object claims.

Depending on the case of application, it can be practical that the split case consists of a chemical-resistant, pressure-resistant, and temperature-resistant glass.

A preferred selection with regard to the glass is seen in that the split case consists of a borosilicate glass that contains not only silicon dioxide as the main component, but also alkali metal oxides in contents of 3 to 9%, aluminum oxide in contents of 1.5 to 8%, earth alkali metal oxides in contents of up to 6%, and boron trioxide in contents of 6 to 14%.

In accordance with another idea of the invention, the basic body for the split case is formed by a glass tube that is formed by means of the influence of temperature and pressure, to produce the split case, in such a manner that a closed bottom occurs in the region of the one tube end, and a projection occurs in the region of the other tube end.

Alternatively, there is also the possibility of producing the split case under the effect of pressure and temperature, by pressing a glass blank.

With regard to the material selection, however, there is also the possibility of using such magnetic couplings, equipped with split cases consisting of glass, in compressors and ventilators, i.e. in the case of magnetic couplings that run dry.

With the object of the invention, a magnetic coupling and a split case for a magnetic coupling, respectively, are made available, which coupling or case, in a similar form as in the case of a split case consisting of ceramic material, has similar functions with regard to eddy current losses and temperatures, whereby the energy saving of the two products is also the same.

In deviation from a split case consisting of ceramic material, however, the split case consisting of glass has the great advantage that it can be produced significantly more inexpensively, so that the magnetic coupling or the split case, respectively, can also be used in standard-production pumps/compressors/ventilators.

Particular cases of use for pumps, compressors, and ventilators that required a split case consisting of ceramic material up to the present date are now also no longer necessary, since a significantly more inexpensive component consisting of glass is made available.

As compared with split cases consisting of metal, which were used in many instances, it is now also possible to work on further components of the magnetic coupling, because of the use of the object of the invention. In this connection, different types of magnets, or magnets consisting of different materials, can be used, for example, since neither high temperatures nor eddy current losses are present. A further price advantage for the magnetic coupling results from the selection of more inexpensive materials for the magnets.

As has already been mentioned, a great power loss with regard to the eddy currents exists when using a metallic split case. This loss no longer occurs in the split cases according to the invention, so that drive means such as electric motors can also be designed to have a lower power, and in the final analysis, this contributes to a further increase in economic efficiency.

The magnetic coupling according to the invention can preferably be used in the sector of displacer pumps. Reference is made, only as an example, to rotation piston pumps, eccentric screw pumps, impeller pumps.

Furthermore, the magnetic coupling according to the invention can also be advantageously used in the sector of compressors that are used for compressing gas. Again, as an example, reference is made here only to reciprocating piston compressors, rotation compressors, screw compressors.

The object of the invention is shown in the drawing, using an exemplary embodiment, and described as follows. The drawing shows:

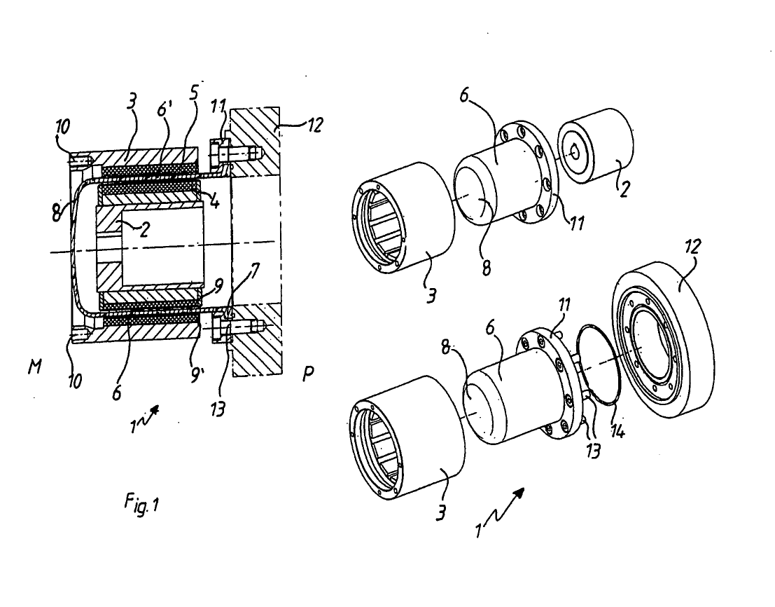

FIG. 1 design structure of a magnetic coupling, in perspective, on the one hand, and in a side view, on the other hand;

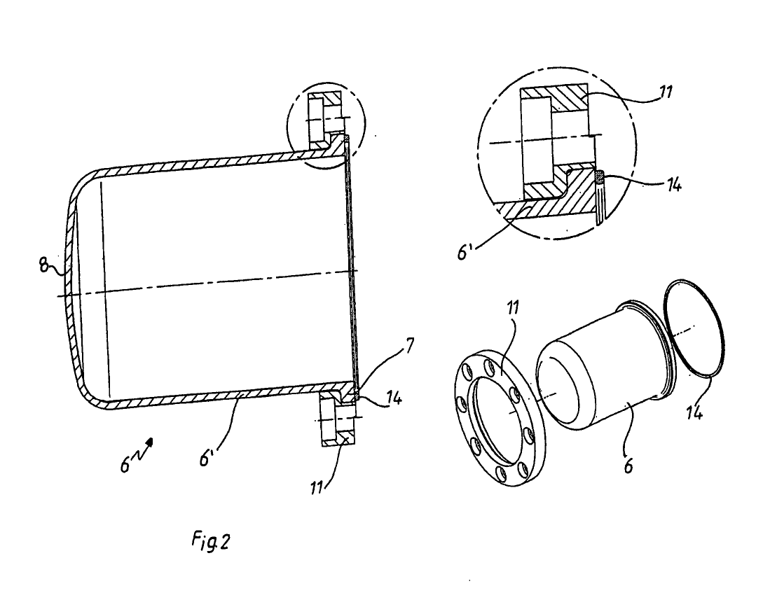

FIG. 2 detail representation of the split case according to FIG. 1, in perspective, on the one hand, and in various individual representations, on the other hand.

FIG. 1 shows the structure of the magnetic coupling 1 according to the invention in perspective, on the one hand, and a partially indicated assembly state of the magnetic coupling 1, on the other hand. The magnetic coupling 1 consists of the following essential components:

an inner rotor 2, an outer rotor 3, both of which are equipped with corresponding magnets 4, 5, as well as a split case 6. The split case 6 has a projection 7 as well as a closed bottom 8. The tube-shaped segment 6′ that extends between the bottom 8 and the projection 7 is positioned, in this connection, in the air gap 9, 9′ between the magnets 4, 5, with minimal play (+/−0.1 mm). The split case 6 consists, according to the invention, of borosilicate glass, which is particularly resistant to chemicals as well as variations in pressure and temperature, and has a heat expansion coefficient of <4×10⁻⁶/K. In the installed situation, the motor side M as well as the pump side P are indicated. On the motor side, threaded bores 10 are introduced into the outer rotor, on which an electric motor (not shown) can be flanged on. By way of a component 11 configured in flange-like manner, the magnetic coupling 1, comprising the inner rotor 2, the outer rotor 3, as well as the split case 6, can be brought into an active connection with a pump flange 12, for example, by way of connection elements 13. A commercially usual O-ring 14 is used for sealing.

FIG. 2 shows the split case 6, consisting of borosilicate glass, according to the invention, the component 11 configured in flange-like manner, as well as the O-ring 14, as an individual representation. The closed bottom 8 as well as the circumferential projection 7 and the tube-shaped segment 6′ that extends between the bottom 8 and the projection 7 can be seen.

The split case 6, consisting of borosilicate glass, can be produced, for example, in that a tube segment having a defined length (excess length) is used and the one tube end is formed into a closed bottom by means of the effect of temperature and pressure, while at the same time, or in a further work step, the projection 7 is formed on by means of the effect of pressure and temperature.

The lowest tolerances with regard to the air gap 9, 9′ can be adhered to by means of the use of high-precision pre-products (tubes).

Alternatively, of course, there is also the possibility of producing the split case 6 under the effect of temperature and pressure by pressing a glass blank, whereby here, however, disadvantages in connection with the tolerances must be accepted.

### REFERENCE SYMBOL LIST

1 magnetic coupling
2 inner rotor
3 outer rotor
4 magnet
5 magnet
6 split case
6′ tube-shaped segment
7 projection
8 bottom
9 air gap
9′ air gap
10 threaded bore
11 flange-like component
12 pump flange
13 connection element
O-ring

1. Magnetic coupling, comprising at least an inner rotor (2), an outer rotor (3), and a split case (6) consisting of electrically non-conductive material, disposed between inner (2) and outer rotor (3), wherein the split case (6) consists exclusively of glass.

2. Magnetic coupling according to claim 1, wherein the split case (6) consists of a chemical-resistant, pressure-resistant, and temperature-resistant glass, which particularly has a heat expansion coefficient of <4×10⁻⁶/K.

3. Magnetic coupling according to claim 1, wherein the split case (6) consists of a borosilicate glass that contains not only silicon dioxide as the main component, but also alkali metal oxides in contents of 3-9%, aluminum oxide in contents of 1.5-8%, earth alkali metal oxides in contents of up to 6%, and boron trioxide in contents of 6-14%.

4. Magnetic coupling according to claim 1, wherein the basic body for the split case (6) is formed by a glass tube that is formed by means of the influence of temperature and pressure, to produce the split case (6), in such a manner that a closed bottom (8) occurs in the region of the one tube end, and a projection (7) occurs in the region of the other tube end.

5. Magnetic coupling according to claim 1, wherein the split case (6) is formed by means of pressing a glass blank.

6. Magnetic coupling according to claim 1, which can be used in the sector of a liquid pump, particularly a displacer pump.

7. Magnetic coupling according to claim 1, which can be used in the sector of a compressor or a ventilator.

8. Split case for a magnetic coupling (1), consisting of an electrically non-conductive material, wherein the material consists exclusively of glass.

9. Split case according to claim 8, wherein the glass is a chemical-resistant, pressure-resistant, and temperature-resistant glass.

10. Split case according to claim 9, wherein the glass is formed by a borosilicate glass that contains not only silicon dioxide as the main component, but also alkali metal oxides in contents of 3-9%, aluminum oxide in contents of 1.5-8%, earth alkali metal oxides in contents of up to 6%, and boron trioxide in contents of 6 to 14%.

11. Split case according to claim 8, wherein the basic body for the split case (6) is formed by a glass tube that is formed by means of the influence of temperature and pressure, to produce the split case (6), in such a manner that a closed bottom (8) occurs in the region of the one tube end, and a projection (7) occurs in the region of the other tube end.

12. Split case according to claim 8, produced by means of pressing a glass blank.
